(19) United States
(12) Patent Application Publication
(10) Pub. No.: US 2026/0156215 A1
(43) Pub. Date: Jun. 4, 2026

(54) SYSTEM FOR ENHANCING EMERGENCY CALLS WITH CALLER BATTERY INFORMATION

(71) Applicant: T-Mobile USA, Inc., Bellevue, WA (US)

(72) Inventors: Manikanta Kumar Teja Penumatsha, Redmond, WA (US); Jenniffer Lucas Cruz, Renton, WA (US); Barbara Maria Elena Diaz Manjarrez, Lynnwood, WA (US); Sudhanshu Pandey, Sammamish, WA (US)

(21) Appl. No.: 18/969,119

(22) Filed: Dec. 4, 2024

(51) Int. Cl. H04M 3/51; H04W 4/029; H04W 4/90; H04W 52/02; H04W 76/50

(52) U.S. Cl. CPC H04M 3/5116; H04M 3/5133; H04W 4/029; H04W 4/90; H04W 52/0261; H04W 76/50

(57) ABSTRACT

The system receives, from a wireless device on a telecommunications network, a first request to establish an emergency call with a public safety answering point using a first header field of a communication protocol. The communication protocol includes diameter protocol, session initiation protocol, long-term evolution positioning protocol, or hypertext transfer protocol 2. The system transmits, to the wireless device, a second request from the public safety answering point for battery information of the wireless device using a second header field of the communication protocol. The system receives, based on the second request, battery information from the wireless device at the public safety answering point using a third header field of the communication protocol. All three header fields can be transmitted using either the same or a different communication protocol. The system modifies emergency call procedures based on the battery information received from the wireless device.

### BACKGROUND

Caller identification (ID) is a telephone service available in analog and digital telephone systems, including Voice over Internet Protocol (VoIP), that transmits a caller's telephone number to the called party's telephone equipment when the call is being set up. The caller ID service may include the transmission of a name associated with the calling telephone number in a service called Calling Name Presentation (CNAM). The information received from the service is displayed on a telephone display screen, on a separately attached device, or on other displays, such as cable television sets when the same vendor provides telephone and television service.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram that illustrates transmission of battery information to a public safety answering point (PSAP).

FIG. 4 is a flowchart that illustrates an embodiment of the system.

FIG. 5 is a block diagram that illustrates components of a computing device.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to a system for enhancing features for emergency service calls. Emergency services are contacted via a public safety answering point (PSAP). A PSAP is a type of call center where telephone calls from members of the public to first responders or emergency services (such as police, fire department, or emergency medical services/ambulance) are received and handled. The PSAP takes calls from any landline, mobile phone line, or Voice over Internet Protocol (VoIP) line. An originating caller can call a PSAP from a wireless device with a low battery percentage or in a low power mode. Low power mode is a feature native to many wireless devices that restricts certain features on the wireless device, such as certain location services. During the call, the PSAP constantly requests location data from the wireless device. For example, the PSAP can request the location data every 10, 20, 30, etc., seconds. Constantly transmitting the location data to the PSAP causes the wireless device to consume more power, leading to the wireless device running out of power before the call is over. Additionally, the location data cannot be transmitted to the PSAP when the wireless device is in low power mode, meaning that the PSAP is not able to determine the location of the wireless device.

The disclosed technology provides a system that enables PSAPs to receive battery information about a wireless device to adjust PSAP calling procedures when the wireless device has a battery percentage below a threshold level. For example, the system causes the wireless device to transmit battery information, including a battery level percentage and/or an indication of whether the wireless device is currently charging. The battery information can be transmitted as header fields using the diameter protocol, session initiation protocol (SIP), long-term evolution (LTE) positioning protocol (LPP), and/or hypertext transfer protocol (HTTP) 2. Using different protocols can enable the battery information to be transmitted using different network generations (e.g., 5G, LTE, 3G, etc.). The system receives the battery information and can display it for the PSAP, for example, on the PSAP operator's screen. The system can use the battery information to extend the battery life of the wireless device by, for example, adjusting the frequency with which the PSAP requests location data from the wireless device, adjusting the call's audio quality, and/or causing the wireless device to enter a low power mode.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

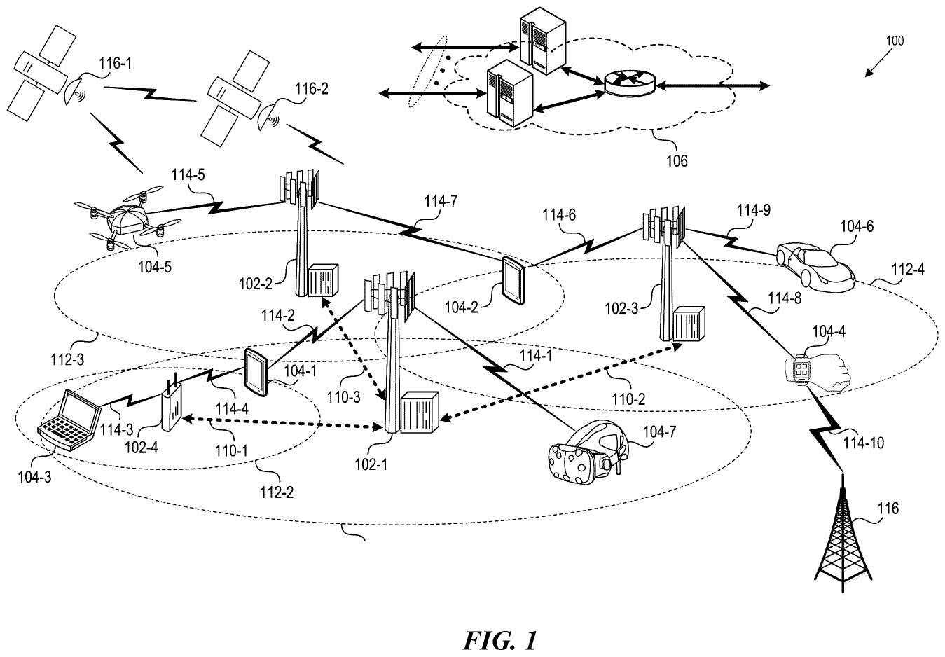

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

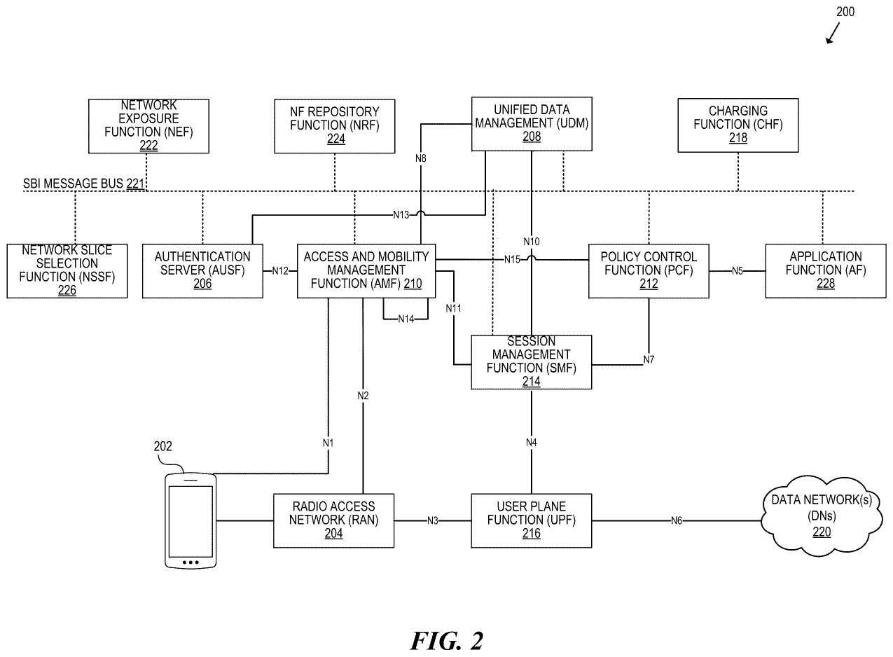

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Enhanced PSAP Call

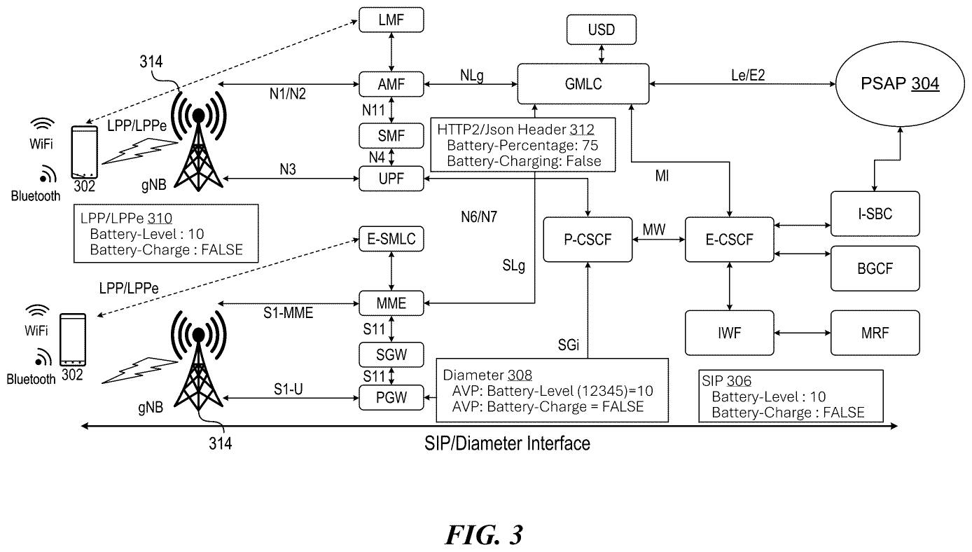

FIG. 3 is a block diagram of an embodiment of the system and call flow for providing battery information from a wireless device 302 to a PSAP 304. The battery information can be transmitted using session initiation protocol (SIP), diameter protocol, long-term evolution positioning protocol (LPP), and/or hypertext transfer protocol (HTTP) 2. Each protocol enables a different method of transmitting information using a header field between the wireless device 302 and the PSAP 304 over the telecommunications network 314. The header field enables the system to transmit the battery information between the wireless device 302 and the PSAP 304 no matter how the emergency call is made (e.g., on an LTE or 5G network). Additionally, the different protocols can enable the system to adjust different procedures to reduce the battery drain on the wireless device 302 caused by the emergency call. The battery information can include a battery level and a battery charge status. The battery charge status indicates whether the wireless device is charging and connected to a power source.

The battery information can be transmitted to the PSAP 304 using a SIP, specifically the SIP priority header field 306. SIP is a signaling protocol used for initiating, maintaining, and terminating communication sessions that include voice, video, and messaging applications on the telecommunications network 314. A SIP priority header field 306 can indicate the urgency of a request as perceived by the client. For example, the SIP priority header field 306 can have values such as “non-urgent,” “normal,” “urgent,” or “emergency.” Additional values can be defined and used as well. The SIP priority header field 306 within a SIP session can include battery information. When the SIP priority header field 306 includes “battery-level,” the PSAP 304 receives the wireless device 302's battery level or percentage represented as a single number (e.g., 10, 20, 50, 75, or 100). When the SIP priority header field 306 includes “battery-charge,” the PSAP 304 receives an indication of the charge status of the wireless device 302. For example, receiving “false” in the SIP priority header field 306 can indicate that the wireless device 302 is not charging, while “true” can indicate that the wireless device 302 is charging.

The battery information can be transmitted to the PSAP 304 using the diameter protocol. Diameter is a messaging protocol that provides authentication, authorization, and accounting (AAA) services for networks. Diameter is used in 3G, IP Multimedia Systems (IMS), LTE/4G, and 5G networks. Diameter's AAA services are the basis for service administration in telecommunications. The AAA services determine which services a user can access, at what quality of service (QoS), and at what cost. Diameter and SIP are both vital in IMS networks. SIP is responsible for setting up and managing real-time IP communication sessions, while diameter handles tasks such as authentication, authorization, and ensuring accurate billing information for these sessions. Together, SIP and diameter form a crucial partnership in ensuring effective and secure communication services within IMS networks. Diameter uses header fields called attribute-value pairs (AVPs) 308 to carry the application data or information between two points (e.g., between the wireless device and the PSAP). Different diameter applications can define their own set of AVPs 308, enabling customization for specific use cases while still maintaining a common protocol structure. When a diameter message is received, the receiving node parses the AVPs 308 to extract the relevant information based on their attribute identifiers. The AVPs 308 can include battery information. When the AVPs 308 include “battery-level,” the PSAP 304 receives the wireless device 302's battery level or percentage represented as a single number (e.g., 10, 20, 50, 75, or 100). When the AVPs 308 include “battery-charge,” the PSAP 304 receives an indication of the charge status of the wireless device 302, such as “false” for not charging or “true” for charging.

The battery information can be transmitted to the PSAP 304 using LPP. LPP is a mechanism to facilitate the exchange of positioning information between a device and the telecommunications network 314. LPP allows the exchange of positioning data between the LTE network of the telecommunications network 314 and the wireless device 302 to enable the PSAP 304 to receive location data from the wireless device 302. The location data can be used to determine the location of the wireless device 302. The location data is requested by the PSAP 304 using an LPP header 310 and transmitted by the wireless device 302 also with an LPP header 310. The frequency with which the positioning information is exchanged between the wireless device 302 and the telecommunications network 314 is typically standardized by emergency call procedures. For example, the frequency can be every 1, 10, 20, or 30 seconds. The LPP header 310 can also include battery information. When the LPP header 310 includes “battery-level,” the PSAP 304 receives the wireless device 302's battery level or percentage represented as a single number (e.g., 10, 20, 50, 75, or 100). When the LPP header 310 includes “battery-charge,” the PSAP 304 receives an indication of the charge status of the wireless device 302.

The battery information can be transmitted to the PSAP 304 using HTTP 2. HTTP 2 is an application-layer protocol that allows signaling between 5G network functions (NFs). HTTP 2 is used to implement control plane communications between NFs in the 5G Core (5GC). HTTP 2 messages can contain JavaScript Object Notation (JSON) payloads, which can include message header fields 312. The message header fields 312 are a list of strings sent and received by both the client program and the server on every HTTP request and response. These message header fields 312 are usually invisible to the end user and are only processed or logged by the server and client applications. When the message header field 312 includes “battery-level,” the PSAP 304 receives the wireless device 302's battery level or percentage represented as a single number (e.g., 10, 20, 50, 75, or 100). When the message header field 312 includes “battery-charge,” the PSAP 304 receives an indication of the charge status of the wireless device 302.

When the PSAP 304 receives the battery information from the wireless device 302, the system can adjust emergency call procedures based on the battery information to preserve the battery life of the wireless device 302. In some embodiments, the battery information is displayed to a PSAP operator. The system can adjust the frequency with which the wireless device 302 provides positioning data to the PSAP 304. The system can cause the wireless device 302 to provide the positioning data at intervals longer than is standardized by the emergency call procedures. For example, when the wireless device 302 is not charging and has a battery level of 20 percent, the system can increase the interval by a predetermined ratio, such as doubling or tripling the length of time between requests. If the battery level of the wireless device 302 drops to 10 percent, the system can further increase the interval by either the same or a different predetermined ratio. Increasing the interval can reduce the amount of energy consumed by the wireless device 302, which enables the completion of the emergency call before the wireless device 302 runs out of battery.

The system can adjust the audio call quality based on the received battery information. For example, the system can adjust the call codex to reduce the battery drain on the wireless device 302 while still retaining the ability for the PSAP operator and the emergency caller to effectively hear and speak to each other. The system can also cause the wireless device 302 to enter the low power mode that is native to the wireless device 302. In some embodiments, the system can cause the wireless device 302 to turn the low power mode on and off based on the needs of the PSAP operator. Adjusting the call quality of the emergency call, causing the wireless device 302 to enter low power mode, and decreasing the frequency with which the wireless device 302 transmits positioning data can reduce the power consumption of the wireless device 302. Decreasing the amount of energy consumed by the wireless device 302 reduces the amount of greenhouse gas emissions. Every year, approximately 40 billion tons of CO₂ are emitted around the world. Power consumption by digital technologies, including telecommunications networks, accounts for approximately 4 percent of this figure. For example, the average U.S. power plant expends approximately 600 grams of carbon dioxide for every kWh generated. Reducing the power consumption of the wireless device 302 can reduce the amount of power drawn from a power plant, which can reduce the amount of carbon dioxide and greenhouse gases emitted by the power plant.

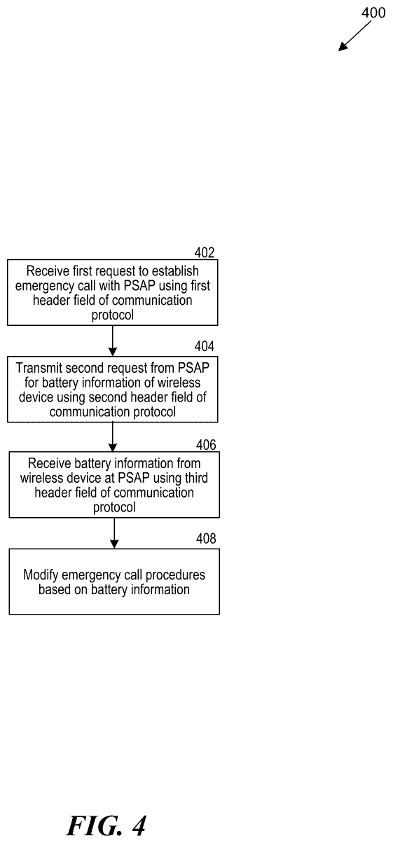

FIG. 4 is a flowchart that illustrates an embodiment of the system. In some embodiments, the system includes at least one hardware processor and at least one non-transitory memory storing instructions, which, when executed by the at least one hardware processor, cause the system to perform the process 400.

At 402, the system receives, from a wireless device on a telecommunications network, a first request to establish an emergency call with a PSAP using a first header field of a communication protocol. The communication protocol includes diameter protocol, SIP, LPP, or HTTP 2. At 404, the system transmits, to the wireless device, a second request from the PSAP for battery information of the wireless device using a second header field of the communication protocol. The second request is received using either a same or a different communication protocol as the first request.

At 406, the system receives, based on the second request, battery information from the wireless device at the PSAP using a third header field of the communication protocol. The third header field is transmitted using either a same or a different communication protocol as the first or second header field. The battery information can include a battery level percentage or a battery charging status. In some embodiments, the system generates an alert when the battery information indicates the battery level percentage of the wireless device is below a threshold level. The system displays the alert on a PSAP operator screen. In some other embodiments, the battery information is recorded in an emergency call log.

At 408, the system modifies emergency call procedures based on the battery information received from the wireless device. In some embodiments, the system adjusts a call quality level of the emergency call when the battery information indicates the battery level percentage is below a threshold level. In some other embodiments, the system lowers the frequency with which the PSAP requests location data from the wireless device based on the received battery information. In yet some other embodiments, the system causes the wireless device to enter a low power mode. In yet some other embodiments, the system reduces a power consumption of the wireless device by modifying the emergency call procedures. The system lowers an amount of greenhouse gas emissions produced by the wireless device by reducing the power consumption of the wireless device and a frequency with which the wireless device draws energy from a power grid.

In some other embodiments, the system transmits, by a wireless device on a telecommunications network, a first request to establish an emergency call with a PSAP using a first header field of a communication protocol. The communication protocol includes diameter protocol, SIP, LPP, or HTTP 2. When the communication protocol is the diameter protocol, the header field is transmitted as an attribute-value pair. The system receives, by the wireless device, a second request from the PSAP for battery information of the wireless device using a second header field of the communication protocol. The second request is received using either a same or a different communication protocol as the first request. The battery information can include battery level percentage or battery charging status. The second request can cause the system to adjust a call audio quality of the emergency call. The second request can cause the system to cause the wireless device to enter a low power mode. The system transmits, based on the second request, battery information to the PSAP using a third header field of the communication protocol. The third header field is transmitted using either a same or a different communication protocol as the first or second header field. The PSAP can access the battery information included in the third header field. The system can increase an interval at which the wireless device transmits location data to the PSAP.

### Computer System

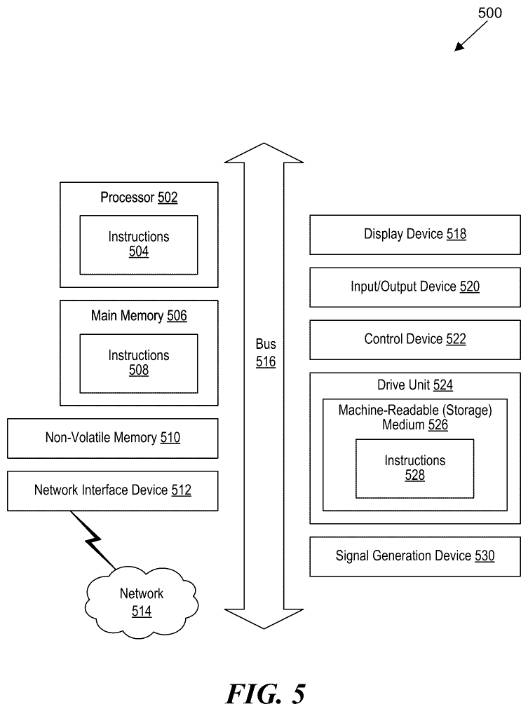

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A non-transitory, computer-readable storage medium comprising instructions recorded thereon, wherein the instructions, when executed by at least one data processor of a system, cause the system to:
transmit, by a wireless device on a telecommunications network, a first request to establish an emergency call with a public safety answering point using a first header field of a communication protocol,
wherein the communication protocol includes: diameter protocol, session initiation protocol, long-term evolution positioning protocol, or hypertext transfer protocol 2;
receive, by the wireless device, a second request from the public safety answering point for battery information of the wireless device using a second header field of the communication protocol,
wherein the second request is received using either a same or a different communication protocol as the first request; and
transmit, based on the second request, battery information to the public safety answering point using a third header field of the communication protocol,
wherein the third header field is transmitted using either a same or a different communication protocol as the first or second header field, and
wherein the public safety answering point accesses the battery information included in the third header field.

2. The non-transitory, computer-readable storage medium of claim 1, wherein the battery information includes a battery level percentage or a battery charging status.

3. The non-transitory, computer-readable storage medium of claim 1, wherein the second request further causes the system to:
adjust a call audio quality of the emergency call.

4. The non-transitory, computer-readable storage medium of claim 1, wherein the second request further causes the system to:
cause the wireless device to enter a low power mode.

5. The non-transitory, computer-readable storage medium of claim 1, further caused to:
lower a frequency at which the wireless device transmits location data to the public safety answering point.

6. The non-transitory, computer-readable storage medium of claim 1, wherein when the communication protocol is the diameter protocol, a header field is transmitted as an attribute-value pair.

7. A system comprising:
at least one hardware processor; and
at least one non-transitory memory storing instructions, which, when executed by the at least one hardware processor, cause the system to:
receive, from a wireless device on a telecommunications network, a first request to establish an emergency call with a public safety answering point using a first header field of a communication protocol,
wherein the communication protocol includes: diameter protocol, session initiation protocol, long-term evolution positioning protocol, or hypertext transfer protocol 2;
transmit, to the wireless device, a second request from the public safety answering point for battery information of the wireless device using a second header field of the communication protocol,
wherein the second request is received using either a same or a different communication protocol as the first request;
receive, based on the second request, battery information from the wireless device at the public safety answering point using a third header field of the communication protocol,
wherein the third header field is transmitted using either a same or a different communication protocol as the first or second header field; and
modify emergency call procedures based on the battery information received from the wireless device.

8. The system of claim 7, wherein the battery information includes a battery level percentage or a battery charging status.

9. The system of claim 8, further caused to:
generate an alert when the battery information indicates the battery level percentage of the wireless device is below a threshold level; and
display the alert on a public safety answering point operator screen.

10. The system of claim 8, further caused to:
adjust a call quality level of the emergency call when the battery information indicates the battery level percentage is below a threshold level.

11. The system of claim 7, further caused to:
lower a frequency with which the public safety answering point requests location data from the wireless device based on the received battery information.

12. The system of claim 7, further caused to:
cause the wireless device to enter a low power mode.

13. The system of claim 7, wherein the battery information is recorded in an emergency call log.

14. The system of claim 7, further caused to:
reduce a power consumption of the wireless device by modifying the emergency call procedures; and
lower an amount of greenhouse gas emissions produced by the wireless device by reducing the power consumption of the wireless device and a frequency with which the wireless device draws energy from a power grid.

15. A method comprising:
receiving, from a wireless device on a telecommunications network, a first request to establish an emergency call with a public safety answering point using a first header field of a communication protocol,
wherein the communication protocol includes: diameter protocol, session initiation protocol, long-term evolution positioning protocol, or hypertext transfer protocol 2;
transmitting, to the wireless device, a second request from the public safety answering point for battery information of the wireless device using a second header field of the communication protocol;
receiving, based on the second request, battery information from the wireless device at the public safety answering point using a third header field of the communication protocol; and
modifying emergency call procedures based on the battery information received from the wireless device.

16. The method of claim 15, wherein the battery information includes a battery level percentage or a battery charging status.

17. The method of claim 16, further comprising:
generating an alert when the battery information indicates the battery level percentage of the wireless device is below a threshold level; and
displaying the alert on a public safety answering point operator screen.

18. The method of claim 16, further comprising:
adjusting a call quality level of the emergency call when the battery information indicates the battery level percentage is below a threshold level.

19. The method of claim 15, further comprising:
lowering a frequency with which the public safety answering point requests location data from the wireless device based on the received battery information.

20. The method of claim 15, further comprising:
causing the wireless device to enter a low power mode.
